(19) United States
(12) Patent Application Publication
(10) Pub. No.: US 2011/0211724 A1
(43) Pub. Date: Sep. 1, 2011

(54) EARPHONE

(76) Inventor: Yasuhiro Hirata, Tokyo (JP)

(21) Appl. No.: 12/737,968

(22) PCT Filed: Dec. 22, 2008
(86) PCT No.: PCT/JP2008/073310

§ 371 Date: May 16, 2011

(30) Foreign Application Priority Data
Sep. 26, 2008 (JP) 2008-247455

(51) Int. Cl. H04R 1/10

(52) U.S. Cl. 381/384

(57) ABSTRACT

An earphone that can be used with its using mode selected, to be excellent in the handiness, by optionally changing the cord from its normal hang down state easily to an ear hanging state, or oppositely from the ear hanging state to the hang down state, to meet the user's using state or taste, is provided. The earphone has a front housing 2 provided therein with a driver unit 8, an ear pad 3 covering as fitted to front outer peripheral part of said front housing 2, a rear housing 4 provided on the back of said front housing 2, a bushing 6 provided to said rear housing 4 and having at lower end part a cord lead-out section 6a, and a cord 9 led out of said cord lead-out section 6a, wherein the bushing 6 is rotatable.

### FIELD OF TECHNOLOGY

This invention relates to earphones for listening to music and the like as mounted to ears.

### BACKGROUND ART

The earphones are used by inserting ear pad section of the earphone in an ear hole, while holding earphone housing by means of the tragus and antitragus of the ear. In this case, the earphone is provided at its lower part with a bushing, of which a cord is led out, and this cord is normally hanging down in the case when mounted (hereinafter referred to as “hang down state”).
An example of the prior art is Non-Patent Publication 1: Japanese Design Registration No. 1336084.

### DISCLOSURE OF INVENTION

### Problem the Invention is to Solve

However, there have been problems that, during the use, the cord in the hang down state is caused when the user turns downward, for example, to hang down in front of his face, so as to be an eyesore, and to be in the way, and further that the cord swings to be annoying when the user is walking at quick pace or running.

While these problems may be improved when the cord is put on the ear, there arises even in such case a problem that a stress may be imposed on the cord if the cord is forcibly pulled about the ear and the cord may easily slip away from the ear.

This invention has been proposed in view of the above respects, and its object is to provide an earphone which can be used with its using mode selected to be excellent in the handiness, such that, in response to the user's using state or to the user's taste, the cord can be easily replaced optionally from the normal hang down state to an ear hanging state or, oppositely, from the ear hanging state to the hang down state.

### Means for Solving the Problem

The invention of claim 1 is an earphone having a front housing 2 provided in the interior with a driver unit 8, an ear pad 3 covering as fitted to front outer peripheral part of said front housing, a rear housing 4 provided on the back of said front housing 2, a bushing 6 provided to said rear housing 4 and having at lower end part a cord lead-out section 6a, and a cord 9 led out of said cord lead-out section 6a of said bushing 6; and characterized in that said bushing 6 is rotatable.

The invention of claim 2 is, in the earphone disclosed in claim 1, further characterized in that there is provided within said rear housing 4 a rotatable shaft 11, said bushing 6 being engaged with the shaft 11, and said shaft 11 and bushing 6 are rotatable.

The invention of claim 3 is, in the earphone disclosed in claim 1, characterized in that said bushing 6 of which said cord is led out is rotatable within a range between a hang down state and an ear hanging state of the cord 9.

### Effect of the Invention

According to this invention, the bushing that having the cord is made rotatable, so that the earphone can be used in either one of the hang down state of the cord and the ear hanging state of the cord. Further, as the user can optionally and easily shift the cord from the normal hang down state to the ear hanging state or vice versa, it is possible to attain the earphone that can obtain a comfortable mounting feeling and can be excellent in the handiness.

### BRIEF EXPLANATION OF THE DRAWINGS

FIG. 1 is a side view in an embodiment of the earphone according to the present invention.

FIG. 2 is a fragmentally and summarized sectional view of the earphone in the embodiment of the earphone according to the present invention.

FIG. 3 is a sectioned view along line A-A in FIG. 1.

FIG. 4 shows an example of arrangement for allowing the bushing to be rotated within a predetermined range.

FIGS. 5 (a) and (b) show a state in which the bushing is rotated, (a) being a front view, and (b) being its bottom view.

FIG. 6 (a) shows a front view of the bushing in its rotating process, and FIG. (b) shows its bottom view.

FIG. 7 (a) shows a front view of the bushing in its state rotated on the side opposite to FIG. 5, and FIG. (b) shows its bottom view.

FIG. 8 shows the earphone according to the present invention as mounted to the ear with the cord made in the hang down state.

FIG. 9 shows the earphone according to the present invention in the ear hanging state.

### EXPLANATION OF THE REFERENCE CHARACTERS

1 earphone
2 front housing
2a front housing rear section
3 ear pad
3a inside part
3b space section
3c outside part
3c′ outside part front section
4 rear housing
4a stepped section
4b space section
4c guide groove
5 ring
5a ring body
5b ring bent section
6 bushing
6a cord lead-out section
7 protect screen
8 driver unit
9 cord
10 cover
11 shaft
11a engaging section
11b recessed section
11c stopper

### BEST MODE FOR WORKING THE INVENTION

In the following, an embodiment of the present invention shall be explained with reference to the drawings.

### Embodiment 1

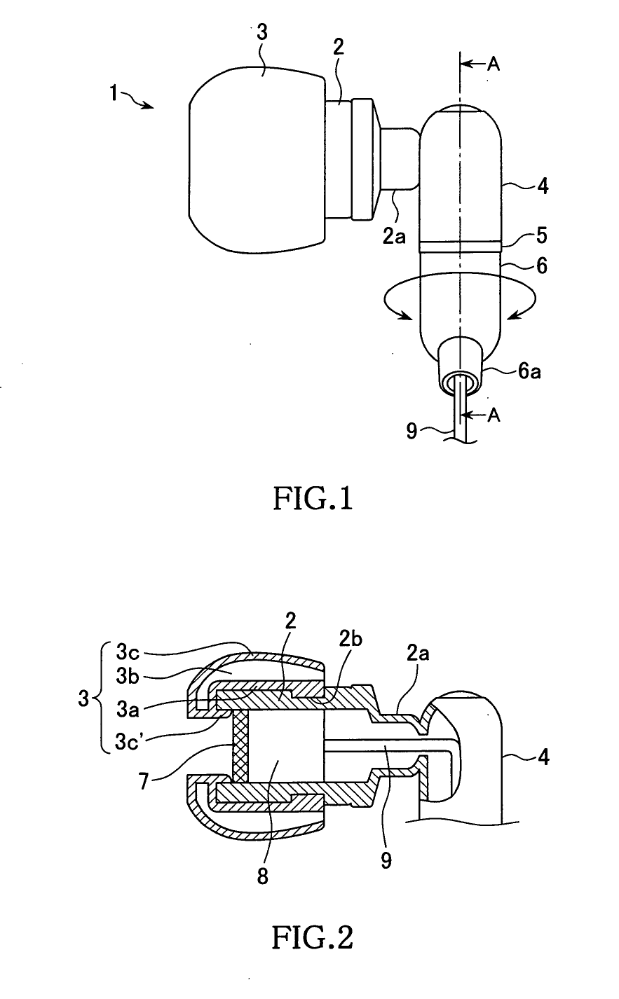

FIG. 1 is a side view of the earphone of the present invention, and

FIG. 2 is a fragmentary summarized sectional view of the earphone of the present invention.

First, in FIG. 1, 1 denotes the earphone, and this earphone 1 consists of a hollow front housing 2 made of a resin or metal, an ear pad 3 covering an outer side at front part of the front housing 2 and made of a soft and elastic material, a rear housing 4 coupled to a rear section 2a of the front housing 2, and a bushing 6 provided through a ring 5 to lower section of the rear housing 4 to be rotatable as shown by an arrow. 6a is a cord lead-out section, and 9 is a cord.

As shown in FIG. 2, the ear pad 3 forms a double structure of an inside part 3a and an outside part 3c the latter of which is positioned outer side of the inside part 3a through a space section 3b. The reason why such double structure with the space section 3b interposed is that the outside part 3c can easily attain its elastic deformation when inserted into the ear hole, and further can easily deform along the shape of the ear hole to be excellent in the feeling with the earphone mounted.

Outer periphery of the front housing 2 is covered by the inside part 3a of the ear pad 3, while the front section 3c′ of the outside part 3c is formed into a shape bent toward the side of the front housing 2 so as to cover front section of the front housing 2. Provided that, in this case, a recessed section 2b is formed in a part of the outer periphery of the front housing 2, the ear pad 3 becomes preferably hard to be detached. By the way, the position of the recessed section 2b should not be limited to the state illustrated. Further, if the inside part 3a of the ear pad 3 is made to closely cover the outer periphery of the front housing 2 so as not to slip off, the recessed part 2b may not be specifically required.

At the front section inside the front housing 2, a protect screen 7 is provided, and a driver unit 8 including a diaphragm and a magnetic circuit for driving the diaphragm is provided on rear side of the protect screen 7. As the arrangement of such driver unit 8 is well known, its interior structure shall be omitted. 9 is a cord connected at one end to a voice coil (not shown) of the driver unit 8 for supplying audio signals. The other end of the cord 9 is led out to the rear housing 4 through a cylindrical rear section 2a formed at rear part of the front housing 2 and to be of a diameter smaller than body part of the front housing 2, and is exposed to the exterior from the cord lead-out section 6a shown in FIG. 1.

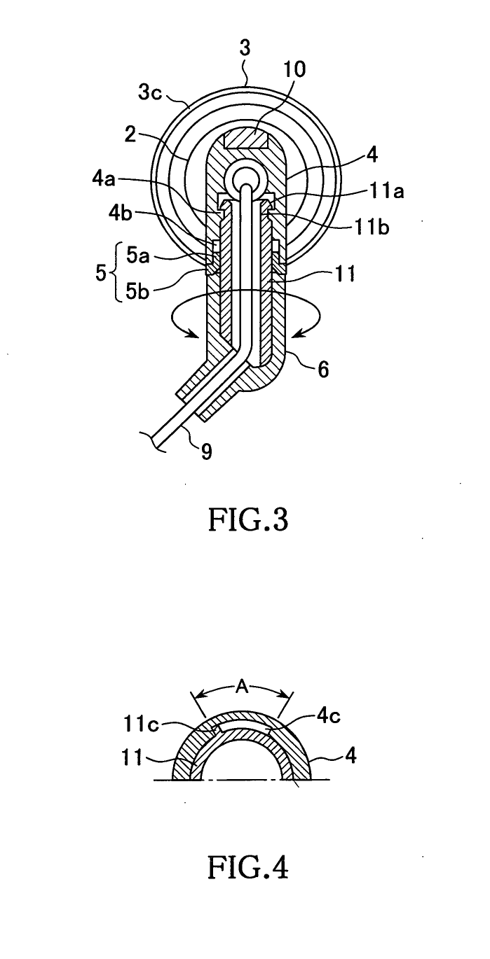

FIG. 3 is a sectional view along line A-A in FIG. 1 and shows interior structure with the rear housing 4, the bushing 6 and so on.

The rear housing 4 is formed, in the illustrated state, to be in a reverse U shape, and is provided at a tip end section with a cover 10. This cover 10 is one for hiding, so as not to be seen, a head of a screw (not shown) fixing the rear housing 4 to the front housing 2. Further, in the rear housing 4, a shaft 11 of a cylindrical shape is provided. At an upper, outer peripheral section of this shaft 11, a hook-shaped engaging section 11a is provided and, at its lower part, a recessed section 11b is formed. A stepped section 4a provided on the inner periphery of the rear housing 4 is formed in a shape substantially fitting to the engaging section 11a and recessed section 11b, and is made to engage in the recessed section 11b and to rotatably support the engaging section 11a, so that the shaft 11 will not be pulled out downward. Further, the bushing 6 is provided through a ring 5 on the outer periphery at lower half of the shaft 11.

A body 5a of the ring 5 is rotatably provided in a space section 4b formed between the outer periphery of the shaft 11 and the lower inner periphery of the rear housing 4. Lower section of the ring 5 is of a shape bent toward outside and, at lower part of such bent section 5b, an upper section of the bushing 6 is mounted.

The inner periphery of this bushing 6 contacts the outer periphery of the shaft 11, and the bushing 6 is made rotatable in a predetermined range as shown by an arrow, together with the shaft 11 and the ring 5. This is for the reason that, if the bushing 6 is allowed to freely rotate by 360 degrees, there arises such risk that the cord is twisted to be damaged or broken.

FIG. 4 is a structural example for allowing the bushing 6 to be ratatable only by a predetermined range. By forming a guide groove 4c in a part of the inner periphery of the rear housing 4, and providing a projection type stopper 11c on the outer periphery of the shaft 11 to be shiftable within the guide groove 4c, the shaft 11 and eventually ring 5 and bushing 6 can be made rotatable with respect to the rear housing 4 by the predetermined range A. It is possible, of course, to employ another means so as to attain the rotation in the predetermined range.

The predetermined range A means the range between the position of the hang down state and the position of the ear hanging state of the cord 9.

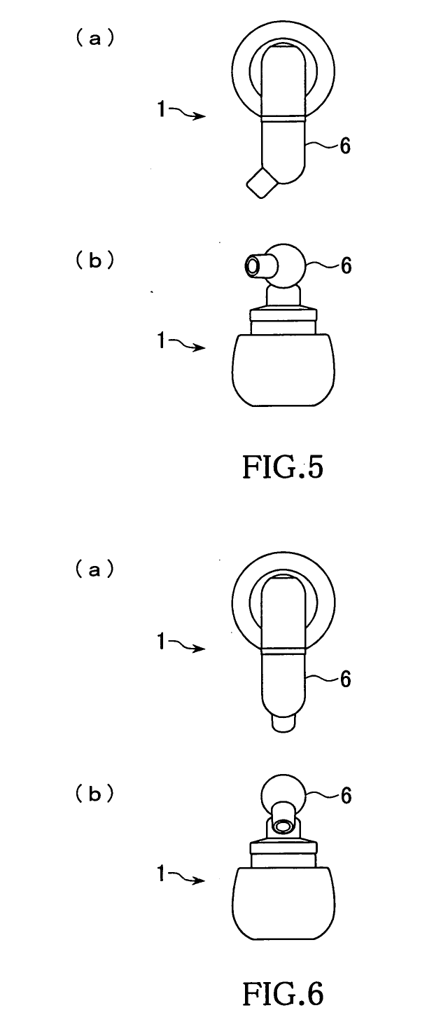

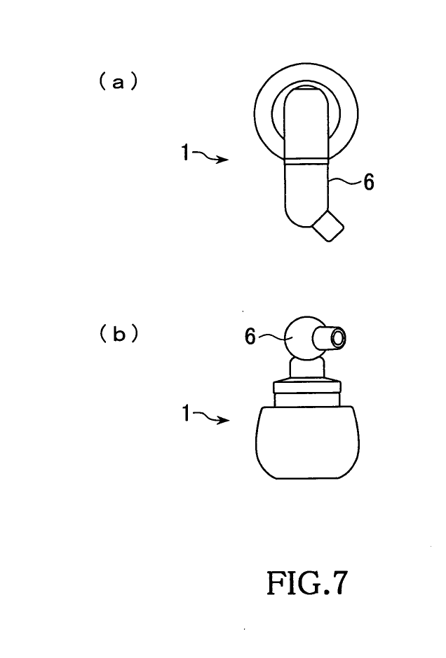

FIG. 5 (a) is a front view of the earphone 1, (b) shows a state as viewed from a lower position of the state (a), and FIGS. 5 (a) and (b) through FIGS. 7 (a) and (b) show rotating states of the bushing 6. When FIGS. 5 (a) and (b) are referred to as being of the cord's hang down state, for example, FIGS. 7 (a) and (b) will be of the cord's ear hanging state.

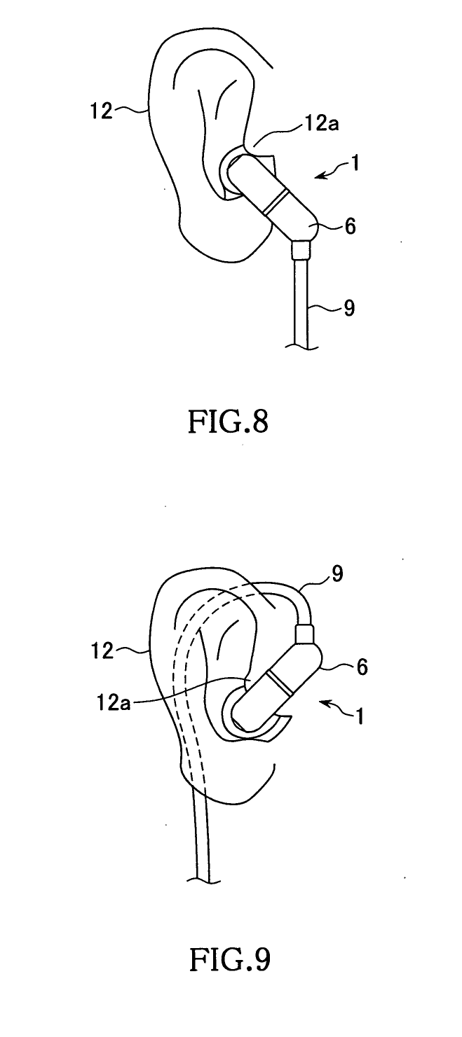

FIG. 8 is a state of the earphone 1 inserted in the hole of ear 12 with the cord 9 in the hang down mode. In the drawing, 12a is the tragus.

FIG. 9 shows a case where the direction of the earphone 1 is rotated toward upper side of the ear 12, and the bushing 6 is rotated to render the cord 9 to be in the ear hanging state.

According to the present invention, as in the foregoing, the earphone can be used in either type of the hang down state or the ear hanging state of the cord, and the mounting state of the earphone 1 with respect to the ear can be easily selected properly as required.

### UTILIZABILITY IN THE INDUSTRY

This invention relates to the earphone that allows the one to personally listen to music and the like. To the earphone, there is provided the cord. The earphone to which the present invention relates can be used in either of the hang down state or the ear hanging state of the cord, and the user can select the using state in accordance with circumstances with the cord made not in the way, so that the handiness of the earphone has been improved.

1. An earphone, having:
a front housing (2) provided in the interior with a driver unit (8),
an ear pad (3) covering as fitted to a front outer peripheral part of said front housing (2),
a rear housing (4) provided on the back of said front housing (2),
a bushing (6) provided to said rear housing (4) and having at lower end part a cord lead-out section (6a), and
a cord (9) led out of said cord lead-out section (6a) of said bushing (6);
wherein said bushing (6) is engaged with said shaft (11), said shaft (11) and said bushing (6) are rotatable, and
said bushing (6) of which said cord (9) is led out is rotatable within a range between a hang down state and an ear hanging state of the cord (9).

2. (canceled)

3. (canceled)
